(19) United States
(12) Patent Application Publication
(10) Pub. No.: US 2022/0236229 A1
(43) Pub. Date: Jul. 28, 2022

(54) ROTATIONAL SPEED DETECTING DEVICE

(71) Applicant: HONDA MOTOR CO., LTD., TOKYO (JP)

(72) Inventors: Xun WANG, WAKO-SHI (JP); Toshio INOUE, WAKO-SHI (JP)

(21) Appl. No.: 17/584,821

(22) Filed: Jan. 26, 2022

(30) Foreign Application Priority Data
Jan. 28, 2021 (JP) 2021-011879

(51) Int. Cl. G01N 29/12; G01N 29/42

(52) U.S. Cl. CPC G01N 29/12; G01N 29/42

(57) ABSTRACT

A rotational speed detecting device that detects an engine rotational speed includes: a frequency estimation unit for estimating a frequency of vehicle interior sound as an estimated frequency based on a period of the vehicle interior sound detected by a microphone; an analysis frequency band setting unit for setting an analysis frequency band based on the estimated frequency; a frequency detection unit for performing spectrum analysis of the vehicle interior sound by discrete Fourier transform in the analysis frequency band and detecting the frequency of the vehicle interior sound as a detection frequency; and a rotational speed calculation unit for calculating an engine rotational speed based on the detection frequency.

### CROSS-REFERENCE TO RELATED APPLICATIONS

This application is based upon and claims the benefit of priority from Japanese Patent Application No. 2021-011879 filed on Jan. 28, 2021, the contents of which are incorporated herein by reference.

### BACKGROUND OF THE INVENTION

### Field of the Invention

The present invention relates to a rotational speed detecting device.

### Description of the Related Art

JP 2008-116408 A discloses a tachometer. This tachometer performs spectrum analysis by performing fast Fourier transform of vibration caused by rotation of a rotary motor, and calculates the rotational speed of the rotary motor based on the analysis result.

### SUMMARY OF THE INVENTION

Since the computational load of the fast Fourier transform is high, it is necessary to install a processor having high computing power in the tachometer. Therefore, the technique disclosed in JP 2008-116408 A has a problem that the cost of the tachometer increases.

It is an object of the present invention to provide a rotational speed detecting device capable of suppressing a computational load when detecting a rotational speed of a measurement object, and reducing a cost.

According to an aspect of the present invention, provided is a rotational speed detecting device that detects a rotational speed of a measurement target, the rotational speed detecting device comprising: a frequency estimation unit configured to estimate, based on a period of vibration caused by rotational motion of the measurement target, a frequency of the vibration as an estimated frequency, the vibration being detected by a physical phenomenon detection unit; an analysis frequency band setting unit configured to set an analysis frequency band based on the estimated frequency; a frequency detection unit configured to perform, in the analysis frequency band, spectrum analysis of the vibration detected by the physical phenomenon detection unit by discrete Fourier transform, and detect a frequency of the vibration as a detection frequency; and a rotational speed calculation unit configured to calculate the rotational speed of the measurement target based on the detection frequency.

According to the present invention, it is possible to suppress a computational load when detecting the rotational speed of the measurement object and to reduce the cost of the rotational speed detecting device.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram of a rotational speed detecting device;

FIG. 2 is a flowchart showing a flow of frequency estimation processing executed by a frequency estimation unit;

FIG. 3 is a graph showing a time change of a processed signal;

FIG. 4 is a block diagram of the rotational speed detecting device;

FIG. 5 is a block diagram of a subsequent-stage frequency estimation unit; and

FIG. 6 is a graph showing gain characteristics of peak filters.

### DESCRIPTION OF THE INVENTION

### First Embodiment

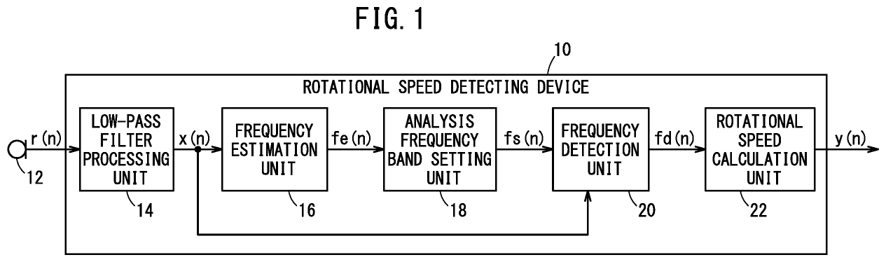

FIG. 1 is a block diagram of a rotational speed detecting device 10 of the present embodiment. The rotational speed detecting device 10 detects an engine rotational speed y(n) of an automobile from sound collected by a microphone 12. The microphone 12 is installed in a vehicle interior of the automobile and collects vehicle interior sound. A sound signal r(n) is input to the rotational speed detecting device 10 at regular sampling intervals. The microphone 12 generates the sound signal r(n) by performing digital conversion of the vehicle interior sound collected at regular sampling intervals. Every time the sound signal r(n) is input, the rotational speed detecting device 10 outputs an engine rotational speed y(n). The microphone 12 corresponds to a physical phenomenon detection unit of the present invention. Here, “n” represents the number of time steps.

The rotational speed detecting device 10 includes a low-pass filter processing unit 14, a frequency estimation unit 16, an analysis frequency band setting unit 18, a frequency detection unit 20, and a rotational speed calculation unit 22.

The low-pass filter processing unit 14 generates a processed signal x(n) from the sound signal r(n). The processed signal x(n) is a signal obtained by cutting, from the sound signal r(n), frequencies higher than the frequency of the vehicle interior sound caused by the rotational motion of an engine.

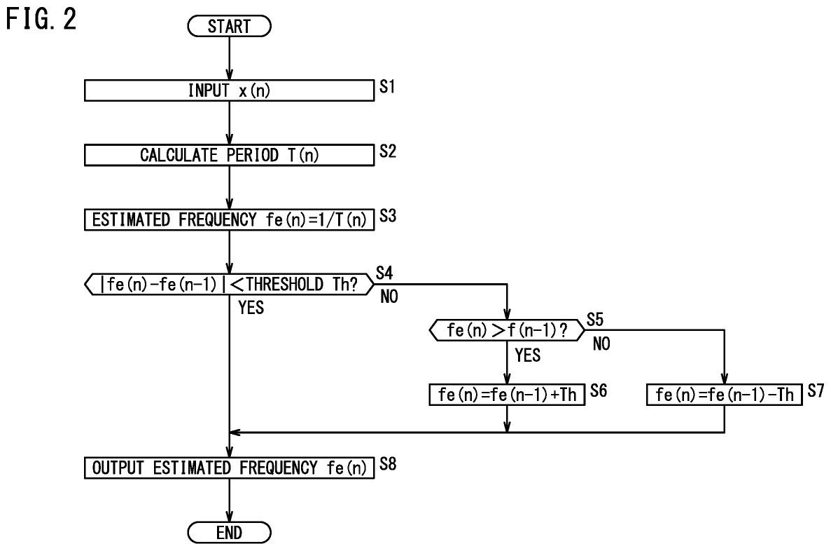

The frequency estimation unit 16 estimates a frequency (estimated frequency fe(n)) of the processed signal x(n). FIG. 2 is a flowchart showing a flow of frequency estimation processing executed by the frequency estimation unit 16. The frequency estimation processing is executed each time the sound signal r(n) is input from the microphone 12 to the rotational speed detecting device 10.

In step S1, the frequency estimation unit 16 acquires the processed signal x(n). Thereafter, the process proceeds to step S2.

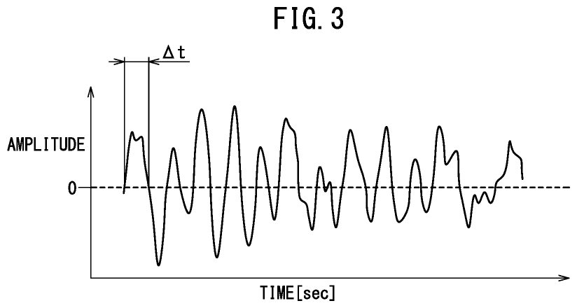

In step S2, the frequency estimation unit 16 calculates a period T(n) of the processed signal x(n). Thereafter, the process proceeds to step S3. The frequency estimation unit 16 calculates the period T(n) of the processed signal x(n) as follows. FIG. 3 is a graph showing a time change of the processed signal x(n). The frequency estimation unit 16 measures a time Δt from when the amplitude of the processed signal x(n) becomes 0 to when the amplitude of the processed signal x(n) becomes 0 again. Then, the frequency estimation unit 16 sets the period T(n) to twice the time Δt.

T(n)=2×ΔT [sec]

In step S3, the frequency estimation unit 16 calculates an estimated frequency fe(n). Thereafter, the process proceeds to step S4. The frequency estimation unit 16 sets the reciprocal of the period T(n) as the estimated frequency fe(n).

fe(n)=1/T(n) [Hz]

In step S4, the frequency estimation unit 16 determines whether or not the absolute value of a difference between the estimated frequency fe(n) and an estimated frequency fe(n−1) is less than a threshold Th. The estimated frequency fe(n) is a frequency calculated in the immediately preceding step S3. The estimated frequency fe(n−1) is a frequency output in step S8 described later in the previous estimation. When the absolute value of the difference between the estimated frequency fe(n) and the estimated frequency fe(n−1) is less than the threshold Th, the process proceeds to step S8. When the absolute value of the difference between the estimated frequency fe(n) and the estimated frequency fe(n−1) is equal to or greater than the threshold Th, the process proceeds to step S5.

In step S5, the frequency estimation unit 16 determines whether or not the estimated frequency fe(n) is greater than the estimated frequency fe(n−1). When the estimated frequency fe(n) is greater than the estimated frequency fe(n−1), the process proceeds to step S6. When the estimated frequency fe(n) is equal to or less than the estimated frequency fe(n−1), the process proceeds to step S7.

In step S6, the frequency estimation unit 16 sets a value obtained by adding the threshold Th to the estimated frequency fe(n−1), as a new estimated frequency fe(n). Thereafter, the process proceeds to step S8.

fe(n)=fe(n−1)+Th [Hz]

In step S7, the frequency estimation unit 16 sets a value obtained by subtracting the threshold Th from the estimated frequency fe(n−1), as a new estimated frequency fe(n). Thereafter, the process proceeds to step S8.

fe(n)=fe(n−1)−Th [Hz]

In step S8, the frequency estimation unit 16 outputs the estimated frequency fe(n) to the analysis frequency band setting unit 18 and the frequency detection unit 20. Thereafter, the frequency estimation processing ends.

The analysis frequency band setting unit 18 sets a range of ±5 [Hz] of the estimated frequency fe(n), as an analysis frequency band fs(n).

fs(n)=[fe(n)−5,fe(n)+5]

The frequency detection unit 20 performs spectral analysis on the processed signal x(n) by discrete Fourier transform in the range of the analysis frequency band fs(n). The frequency detection unit 20 performs discrete Fourier transform without using fast Fourier transform. Hereinafter, when simply described as discrete Fourier transform, it means discrete Fourier transform performed without using fast Fourier transform. The frequency detection unit 20 outputs, to the rotational speed calculation unit 22, a frequency of a component having the largest amplitude in the spectrum, as a detection frequency fd(n) of the processed signal x(n).

The rotational speed calculation unit 22 calculates an engine rotational speed y(n). The engine rotational speed y(n) is calculated based on the following expression.

y(n)=60×fd(n)/M [rpm]

Here, “M” in the above expression is the order M of the engine of the automobile. The rotational speed detecting device 10 may automatically determine the order M based on a vehicle type, an engine type, and the like. The vehicle type, the engine type, and the like are input to the rotational speed detecting device 10 by a user. For example, when the engine is a four cylinder four cycle engine, the order M is 2. The order M may be directly input to the rotational speed detecting device 10 by the user.

When calibration of the rotational speed detecting device 10 is being performed, if the user corrects the engine rotational speed output by the rotational speed detecting device 10, the order M may be set based on the correction content. For example, it is assumed that, when the order M is 1 and the rotational speed output by the rotational speed detecting device 10 is 800 [rpm], the user corrects the engine rotational speed to 1600 [rpm]. In this case, the rotational speed detecting device 10 corrects the order M to 2.

### Operational Effects

The fast Fourier transform is an algorithm for computing discrete Fourier transform at high speed in a computer. Fast Fourier Transform is often used in spectral analysis of vibrations. In order to increase the resolution Δf of the fast Fourier transform, it is necessary to increase the number of data N. On the other hand, in the fast Fourier transform, the number of data N is a power of 2. Therefore, if an attempt is made to increase the resolution Δf of the fast Fourier transform, the number of data N increases rapidly, and the computational load on the computer increases. A computational complexity Af in the fast Fourier transform can be obtained by the following expression.

Af=6N×log₂N

When a sampling frequency Fs is 20 [kHz] and the resolution Δf is 1 [Hz], the required number of data N is 2 to the 15th power, and the computational complexity Af is 2949120. When the sampling frequency Fs is 44.1 [kHz] and the resolution Δf is 1 [Hz], the required number of data N is 2 to the 16th power, and the computational complexity Af is 6291456.

On the other hand, when the discrete Fourier transform is computed without using the fast Fourier transform, the discrete Fourier transform can be computed every 1 [Hz] regardless of the number of data N, and the number of data N does not need to be a power of 2. However, when the spectrum analysis is performed on the entire frequencies, if the discrete Fourier transform is performed without using the fast Fourier transform, the computational complexity increases compared to the case where the discrete Fourier transform is performed using the fast Fourier transform.

Therefore, in the present embodiment, the analysis frequency band setting unit 18 sets the analysis frequency band fs(n). The frequency detection unit 20 performs the discrete Fourier transform in the range of the analysis frequency band fs(n), thereby suppressing the computational complexity of the rotational speed detecting device 10. When the number of analysis frequencies is defined as “Nf”, the computational complexity Ad in the discrete Fourier transform can be obtained by the following expression.

Ad=8Nf×N

When the sampling frequency Fs is 20 [kHz] and the resolution Δf is 1 [Hz], the number of data N is 20000, the number of analysis frequencies Nf is 11, and the computational complexity Ad is 1760000. When the discrete Fourier transform is performed by the method of the present embodiment, the computational complexity can be reduced by about 40% compared to the case of performing the discrete Fourier transform using the fast Fourier transform.

Further, when the sampling frequency Fs is 44.1 [kHz] and the resolution Δf is 1 [Hz], the number of data N is 44100, the number of analysis frequencies Nf is 11, and the computational complexity Ad is 3880800. When the discrete Fourier transform is performed by the method of the present embodiment, the computational complexity can be reduced by about 38% compared to the case of performing the discrete Fourier transform using the fast Fourier transform.

Therefore, in the rotational speed detecting device 10 of the present embodiment, it is possible to suppress a computational load when obtaining the engine rotational speed y(n). Therefore, the computing power of a processor installed in the rotational speed detecting device 10 can be set low, and the cost of the rotational speed detecting device 10 can be reduced.

Further, in the present embodiment, the frequency estimation unit 16 determines whether or not the absolute value of the difference between the estimated frequency fe(n) calculated from the processed signal x(n) and the previous estimated frequency fe(n−1) is equal to or greater than the threshold Th. When the absolute value of the difference between the estimated frequency fe(n) and the estimated frequency fe(n−1) is equal to or greater than the threshold Th and the estimated frequency fe(n) is greater than the estimated frequency fe(n−1), a value obtained by adding the threshold Th to the estimated frequency fe(n−1) is set as a new estimated frequency fe(n). When the absolute value of the difference between the estimated frequency fe(n) and the estimated frequency fe(n−1) is equal to or greater than the threshold Th and the estimated frequency fe(n) is equal to or less than the estimated frequency fe(n−1), a value obtained by subtracting the threshold Th from the estimated frequency fe(n−1) is set as a new estimated frequency fe(n).

The threshold Th is set to a value sufficiently greater than the fluctuation of the frequency accompanying the fluctuation of the engine rotational speed of the automobile in the sampling period. As a result, noise tolerance in the frequency estimation unit 16 can be increased.

### Second Embodiment

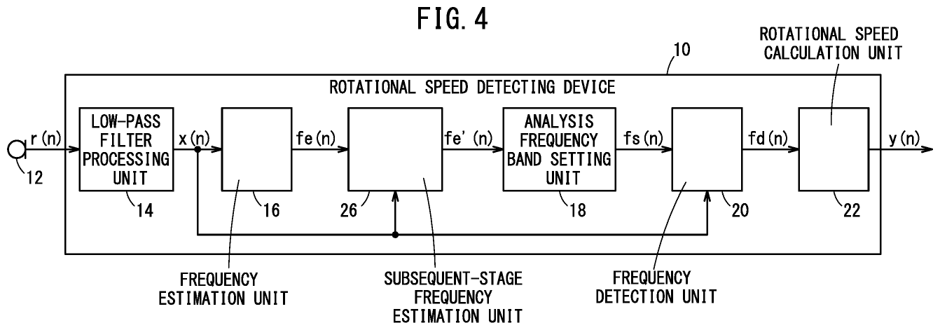

FIG. 4 is a block diagram of the rotational speed detecting device 10 of the present embodiment. In the rotational speed detecting device 10 of the present embodiment, a subsequent-stage frequency estimation unit 26 is added to the rotational speed detecting device 10 of the first embodiment.

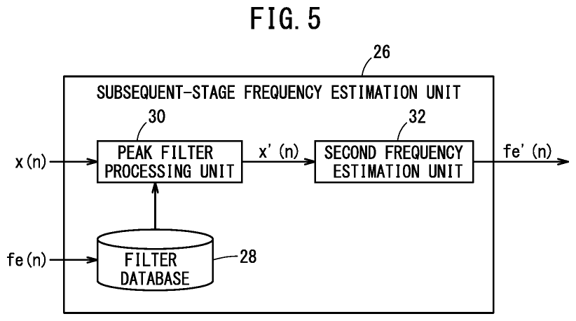

The subsequent-stage frequency estimation unit 26 estimates a frequency (estimated frequency fe′(n)) of the processed signal x(n). FIG. 5 is a block diagram of the subsequent-stage frequency estimation unit 26. The subsequent-stage frequency estimation unit 26 includes a filter database 28, a peak filter processing unit 30, and a second frequency estimation unit 32.

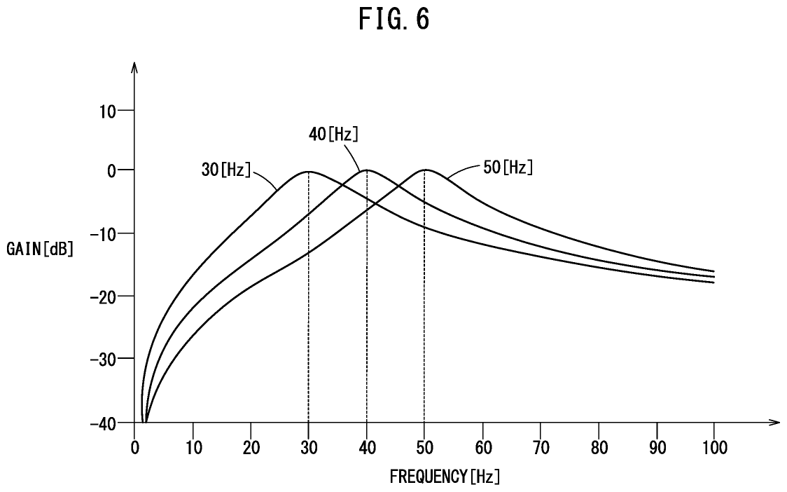

The filter database 28 stores a plurality of peak filters. FIG. 6 is a graph showing gain characteristics of the peak filters. The peak filters are so-called band-pass filters. The peak filters are prepared for every 10 [Hz]. One peak filter is selected in accordance with the estimated frequency fe(n) estimated by the frequency estimation unit 16, and copied to the peak filter processing unit 30. For example, when the estimated frequency fe(n) is equal to or greater than 25 [Hz] and less than 35 [Hz], a peak filter for 30 [Hz] is selected.

The peak filter processing unit 30 filters the processed signal x(n) using the selected peak filter to generate a new processed signal x′(n). The peak filter processing unit 30 corresponds to a filter processing unit of the present invention.

The second frequency estimation unit 32 estimates a frequency (estimated frequency fe′(n)) of the processed signal x′(n). The processing in the second frequency estimation unit 32 is the same as the processing in the frequency estimation unit 16.

The analysis frequency band setting unit 18 sets a range of ±3 [Hz] of the estimated frequency fe′(n) as an analysis frequency band fs(n).

fs(n)=[fe′(n)−3,fe′(n)+3]

In the present embodiment, the range of the analysis frequency band fs(n) set by the analysis frequency band setting unit 18 is narrower than the range of the analysis frequency band fs(n) set by the analysis frequency band setting unit 18 in the first embodiment. The low-pass filter processing unit 14 filters the sound signal r(n) to generate a processed signal x(n). The peak filter processing unit 30 further filters the processed signal x(n) to generate a processed signal x′(n). Therefore, the processed signal x′(n) has less noise than the processed signal x(n). The estimated frequency fe′(n) estimated from the processed signal x′(n) is more accurate than the estimated frequency fe(n) estimated from the processed signal x(n). Thus, in the present embodiment, even if the range of the analysis frequency band fs(n) set by the analysis frequency band setting unit 18 is narrowed, the accuracy of the calculated rotational speed y(n) can be ensured.

### Operational Effects

In the present embodiment, the peak filter processing unit 30 extracts, from the processed signal x(n), frequency components around the estimated frequency fe(n) estimated by the frequency estimation unit 16. Then, the peak filter processing unit 30 outputs the extracted frequency components to the second frequency estimation unit 32 as a new processed signal x′(n). The second frequency estimation unit 32 estimates an estimated frequency fe′(n) from the processed signal x′(n). The analysis frequency band setting unit 18 sets a range of ±3 [Hz] of the estimated frequency fe′(n) as the analysis frequency band fs(n). Then, the frequency detection unit 20 performs discrete Fourier transform in the range of the analysis frequency band fs(n).

When the sampling frequency Fs is 20 [kHz] and the resolution Δf is 1 [Hz], the number of data N is 20000, the number of analysis frequencies Nf is 7, and the computational complexity Ad is 1120000. When the discrete Fourier transform is performed by the method of the present embodiment, the computational complexity can be reduced by about 62% compared to the case of performing the discrete Fourier transform using the fast Fourier transform.

When the sampling frequency Fs is 44.1 [kHz] and the resolution Δf is 1 [Hz], the number of data N is 44100, the number of analysis frequencies Nf is 7, and the computational complexity Ad is 2469600. When the discrete Fourier transform is performed by the method of the present embodiment, the computational complexity can be reduced by about 60% compared to the case of performing the discrete Fourier transform using the fast Fourier transform.

In the present embodiment, processing such as filtering processing in the peak filter processing unit 30 is increased compared to the first embodiment. However, the computational complexity of the discrete Fourier transform can be sufficiently reduced in the present embodiment compared to the computational complexity of the discrete Fourier transform in the first embodiment. Therefore, in the present embodiment, although the computational complexity required for, for example, filtering processing in the peak filter processing unit 30 increases, the computational complexity for the entire rotational speed detecting device 10 can be reduced in the present embodiment compared to the first embodiment.

Thus, the rotational speed detecting device 10 of the present embodiment can further suppress the computational load when detecting the engine rotational speed y(n). Therefore, the computing power of the processor installed in the rotational speed detecting device 10 can be set low, and the cost of the rotational speed detecting device 10 can be reduced.

### Other Embodiments

The rotational speed detecting device 10 according to the first embodiment and the second embodiment detects the engine rotational speed of the automobile based on the vehicle interior sound collected by the microphone 12. Alternatively, the rotational speed detecting device 10 may detect the engine rotational speed of the automobile based on the vehicle body vibration detected by a vibration meter attached to the vehicle body. Further, the rotational speed detected by the rotational speed detecting device 10 is not limited to the engine rotational speed. The rotational speed detecting device 10 may detect the rotational speed of a rotating measurement target such as a propeller shaft or wheels.

Further, the rotational speed detecting device 10 of the second embodiment includes one subsequent-stage frequency estimation unit 26. The rotational speed detecting device 10 may include a plurality of the subsequent-stage frequency estimation units 26. The accuracy of the estimated frequency fe′ can be improved by increasing the number of the subsequent-stage frequency estimation units 26.

### Technical Ideas Obtained from Embodiments

The invention that can be grasped from the above embodiments will be described below.

A rotational speed detecting device (10) that detects a rotational speed of a measurement target includes: a frequency estimation unit (16) configured to estimate, based on a period of vibration caused by rotational motion of the measurement target, a frequency of the vibration as an estimated frequency, the vibration being detected by a physical phenomenon detection unit (12); an analysis frequency band setting unit (18) configured to set an analysis frequency band based on the estimated frequency; a frequency detection unit (20) configured to perform, in the analysis frequency band, spectrum analysis of the vibration detected by the physical phenomenon detection unit by discrete Fourier transform, and detect a frequency of the vibration as a detection frequency; and a rotational speed calculation unit (22) configured to calculate the rotational speed of the measurement target based on the detection frequency.

In the rotational speed detecting device, the frequency estimation unit may estimate the frequency of the vibration at predetermined intervals, may set, as the estimated frequency, the frequency estimated this time, when a difference between the frequency estimated this time and the frequency estimated last time is less than a threshold, and may set, as the estimated frequency, a value obtained by adding the threshold to the frequency estimated last time or a value obtained by subtracting the threshold from the frequency estimated last time, when the difference between the frequency estimated this time and the frequency estimated last time is equal to or greater than the threshold.

The rotational speed detecting device may further include: a filter processing unit (30) configured to extract a frequency component around the estimated frequency from the vibration detected by the physical phenomenon detection unit; and a second frequency estimation unit (32) configured to estimate a frequency of the vibration as a second estimated frequency based on the frequency component extracted by the filter processing unit, wherein the analysis frequency band setting unit may set the analysis frequency band based on the second estimated frequency.

What is claimed is:

1. A rotational speed detecting device that detects a rotational speed of a measurement target, the rotational speed detecting device comprising:
a frequency estimation unit configured to estimate, based on a period of vibration caused by rotational motion of the measurement target, a frequency of the vibration as an estimated frequency, the vibration being detected by a physical phenomenon detection unit;
an analysis frequency band setting unit configured to set an analysis frequency band based on the estimated frequency;
a frequency detection unit configured to perform, in the analysis frequency band, spectrum analysis of the vibration detected by the physical phenomenon detection unit by discrete Fourier transform, and detect a frequency of the vibration as a detection frequency; and
a rotational speed calculation unit configured to calculate the rotational speed of the measurement target based on the detection frequency.

2. The rotational speed detecting device according to claim 1, wherein
the frequency estimation unit:
estimates the frequency of the vibration at predetermined intervals;
sets, as the estimated frequency, the frequency estimated this time, when a difference between the frequency estimated this time and the frequency estimated last time is less than a threshold; and
sets, as the estimated frequency, a value obtained by adding the threshold to the frequency estimated last time or a value obtained by subtracting the threshold from the frequency estimated last time, when the difference between the frequency estimated this time and the frequency estimated last time is equal to or greater than the threshold.

3. The rotational speed detecting device according to claim 1, further comprising:
a filter processing unit configured to extract a frequency component around the estimated frequency from the vibration detected by the physical phenomenon detection unit; and
a second frequency estimation unit configured to estimate a frequency of the vibration as a second estimated frequency based on the frequency component extracted by the filter processing unit, wherein
the analysis frequency band setting unit sets the analysis frequency band based on the second estimated frequency.
